(19) United States
(12) Patent Application Publication
(10) Pub. No.: US 2025/0252188 A1
(43) Pub. Date: Aug. 7, 2025

(54) FIRMWARE UPDATE METHOD FOR EMBEDDED DEVICE, AND EMBEDDED DEVICE

(71) Applicant: ESPRESSIF SYSTEMS (SHANGHAI) CO., LTD., Shanghai (CN)

(72) Inventor: Yuxin WANG, Shanghai (CN)

(21) Appl. No.: 18/856,589

(22) PCT Filed: Apr. 11, 2023
(86) PCT No.: PCT/CN2023/087611

§ 371 Date: Oct. 11, 2024

(30) Foreign Application Priority Data
Apr. 11, 2022 (CN) 202210386463.0

(51) Int. Cl. G06F 21/57; G06F 8/71; G06F 9/4401

(52) U.S. Cl. CPC G06F 21/572; G06F 8/71; G06F 9/4401

(57) ABSTRACT

Disclosed in the present application discloses are a firmware update method for an embedded device and an embedded device. A first firmware partition, a second firmware partition and a bootloader partition are provided in a memory of the embedded device, wherein the first firmware partition is configured to store a first firmware, the second firmware partition is configured to store at least one second firmware, and the first firmware comprises a minimum code set for implementing remote firmware update of the second firmware. The method comprises: detecting a first triggering event for updating the second firmware; determining whether the currently running firmware is the first firmware, and if not, switching the currently running firmware to the first firmware; acquiring, from a source device, second firmware update data for updating the second firmware, and writing received second firmware update data into the second firmware partition.

### CROSS-REFERENCE TO RELATED APPLICATIONS

This application is the U.S. National Phase application under 35 U.S.C. § 371 of International Patent Application No. PCT/CN2023/087611 filed on Apr. 11, 2023, which claims priority to CN patent application No. 2022103864630 filed on Apr. 11, 2022. The disclosures of the aforementioned applications are hereby incorporated by reference in their entireties.

### TECHNICAL FIELD

The present application relates to the field of embedded technology, and in particular to a firmware update method for an embedded device and an embedded device.

### BACKGROUND ART

The rapid development of Internet of Things technology has facilitated the large-scale use of low-cost embedded devices which are widely deployed in application scenarios such as smart homes, smart industries, and healthcare to accomplish functions such as intelligent perception, intelligent control, and intelligent networking. In embedded devices, firmware is usually stored on non-volatile storage devices such as Flash, SD cards, and solid-state drives, and after the device is booted up, the stored firmware is loaded into a RAM memory to perform specified functions. Firmware defines the primary functionality of a product. Device manufacturers often utilize FOTA (Firmware Over the Air) remote firmware update technology to rapidly iterate on device software to meet market demands for product functionality, improve user experience, and remotely fix security vulnerabilities in the firmware.

Existing firmware updates for an embedded device, in order to achieve good fault tolerance, security, and implementability, usually require at least two firmware storage areas of the same size as the firmware, which mainly depends on two limitations: (1) firmware data that has already been loaded into RAM cannot usually be erased; and (2) a backup firmware with OTA function is required to ensure good fault tolerance.

To fully understand the above two aspects, the classic FOTA “ping-pong upgrade” scenario is described as an example. A schematic diagram of storage space partitioning for implementing “ping-pong” upgrade is shown in FIG. 1, in which the bootloader partition is configured to store the system bootloader; the system parameter partition is configured to store data such as a flag bit of the FOTA upgrade, connection network information, and system parameters; the two firmware partitions app_0 and app_1 are configured to store firmware app_0 and app_1 respectively.

The point (1) above means that when the device is running app_0, the system is loading the firmware data of the app_0 partition into the device memory for running, and thus the received new firmware cannot be written into the app_0 partition at this time. The received new firmware can only be written into the app_1 partition, and then the app_1 partition is set as the partition to be booted in the system parameter partition. After rebooting the device, the bootloader will detect the system parameters and load the new firmware in the app_1 partition to complete the firmware update. Similarly, when the device is running app_1, the new firmware can only be written into the app_0 partition, and a similar process as described above is performed to complete the firmware update.

The point (2) above means that the embedded device includes at least two firmwares, app_0 and app_1, that can support the FOTA function. If only one firmware can perform the FOTA function, once the firmware is damaged or becomes unsafe (for example, implanted with a virus program), the device will not be able to perform FOTA safely, causing the device to fail to operate normally.

Although the “ping-pong upgrade” implementation above can realize better FOTA update function, it requires the application of at least two storage areas of the same size as the firmware. The more intelligent or feature-rich the device is, the larger the firmware size tends to be. As a hardware carrier for storing firmware (firmware app_0/firmware app_1), the firmware storage device is not only an indispensable component of the system, but also a main factor that ultimately affects the product price. Higher hardware costs will not only restrict developers from developing intelligent, feature-rich products and promoting the same in the market, but also prevent users from experiencing the rich functions of IoT products at a lower cost.

Therefore, how to solve the problem that embedded devices require more firmware storage space when implementing firmware updates, resulting in high product costs and inability to integrate more device functions is one of the technical problems to be solved urgently in the art.

It is appreciated that the technical problems listed above are only examples and not limitations of the present application, and the present application is not limited to technical solutions that solve all of the above technical problems at the same time. The technical solution of the present application can be implemented to solve one or more of the above or other technical problems.

### SUMMARY

To solve the above and other problems, the present application provides a firmware update method for an embedded device, wherein a first firmware partition, a second firmware partition and a bootloader partition are provided in a memory of the embedded device, wherein the first firmware partition is configured to store a first firmware, the second firmware partition is configured to store at least one second firmware, the first firmware includes a minimum code set for implementing remote firmware update of the second firmware, the bootloader partition is configured to load the first firmware and the second firmware, and the method includes:
detecting a first triggering event for updating the second firmware;
determining whether a currently running firmware is the first firmware, and if not, switching the currently running firmware to the first firmware; and
acquiring, from a source device, second firmware update data for updating the second firmware, and writing received second firmware update data into the second firmware partition to load the second firmware update data in response to switching a running firmware to the second firmware.

Optionally, the first triggering event includes any one of the following:
receiving a push message sent by the source device indicating that there is an updated version of the second firmware; and
sending a query request to the source device as to whether there is an updated version of the second firmware, and receiving a reply message from the source device indicating that there is an updated version.

Optionally, the writing received second firmware update data into the second firmware partition includes:
the second firmware update data is updated second firmware data, replacing the received second firmware data directly with the old second firmware data and writing the received second firmware data into the second firmware partition; or
the second firmware update data is differential data between the old second firmware data and the updated second firmware data, synthesizing the received differential data with the old second firmware data to generate updated second firmware data and writing the updated second firmware data into the second firmware partition.

Optionally, the switching currently running firmware to the first firmware includes:
setting the first firmware as the firmware required to be booted by the bootloader program on the next reboot;
calling a reboot interface to reboot the embedded device; and
running the bootloader program to boot and run the first firmware.

Optionally, the loading the second firmware update data in response to switching the running firmware to the second firmware includes:
setting the second firmware as the firmware required to be booted by the bootloader program on the next reboot;
calling a reboot interface to reboot the embedded device; and
running the bootloader program to boot and run the second firmware, and loading the second firmware update data.

Optionally, before the booting and running the second firmware, the method further includes:
determine whether the second firmware is encrypted firmware, and if yes, performing a decryption operation in the bootloader partition.

Optionally, before the booting and running the second firmware, the method further includes:
performing signature information verification, and/or hash value verification, and/or file header information verification on the second firmware in the bootloader partition; and
if the verification passes, booting and running the second firmware.

Optionally, when there is a plurality of second firmwares, after the performing signature information verification, and/or hash value verification, and/or file header information verification on the second firmware, the method further includes:
in response to that the second firmware to be booted fails the verification, traversing through other second firmwares in the embedded device to perform signature information verification, and/or hash value verification, and/or file header information verification;
in response to that the verification passes, booting and running the second firmware that has passed the verification; or
when there is one second firmware, after the performing signature information verification, and/or hash value verification, and/or file header information verification on the second firmware, the method further includes:
in response to that the second firmware to be booted fails the verification, returning to run the first firmware;
in response to that the verification passes, booting and running the second firmware.

Optionally, the method further includes:
detecting a second triggering event for updating the first firmware;
determine whether the currently running firmware is the second firmware, and if not, switching the currently running firmware to the second firmware;
acquiring, from the source device, first firmware update data for updating the first firmware, and writing received first firmware update data into the first firmware partition to load the first firmware update data in response to switching the running firmware to the first firmware.

Optionally, the writing received first firmware update data into the first firmware partition includes:
the first firmware update data is updated first firmware data, replacing the received first firmware data directly with the old first firmware data and writing the received first firmware data into the first firmware partition; or
the first firmware update data is differential data between the old first firmware data and the updated first firmware data, synthesizing the received differential data with the old first firmware data to generate updated first firmware data and writing the updated first firmware data into the first firmware partition.

Optionally, the loading the first firmware update data in response to switching the running firmware to the first firmware includes:
setting the first firmware as the firmware required to be booted by the bootloader program on the next reboot;
calling a reboot interface to reboot the embedded device;
running the bootloader program to boot and run the first firmware, and loading the first firmware update data.

Optionally, before the booting and running of the first firmware, the method further includes:
performing signature information verification, and/or hash value verification, and/or file header information verification on the first firmware in the bootloader partition;
in response to that the verification passes, booting and running the first firmware.

Optionally, the source device is a cloud server, a local server, a node of a mesh network, or a low-power Bluetooth network device.

Optionally, when there is a plurality of second firmwares, only one of the second firmwares includes a code set for implementing firmware update for the first firmware.

The present application also provides an embedded device, wherein a first firmware partition, a second firmware partition and a bootloader partition are provided in a memory of the embedded device, wherein the first firmware partition is configured to store a first firmware, the second firmware partition is configured to store at least one second firmware, the first firmware includes a minimum code set for implementing remote firmware update of the second firmware, the bootloader partition is configured to load the first firmware and the second firmware, and the firmware stored in the memory is loaded into internal storage of the embedded device to implement any of the firmware update method for an embedded device as described above.

Optionally, the memory is a non-volatile memory.

The firmware update method for an embedded device provided in the present application arranges a first firmware partition, a second firmware partition and a bootloader partition in a memory thereof. The first firmware partition is configured to store the first firmware, and the second firmware partition is configured to store the second firmware. In response to detecting a first triggering event for updating the second firmware, determining whether the currently running firmware is the first firmware, and if not, switching the currently running firmware to the first firmware. Second firmware update data for updating the second firmware is acquired from a source device, and the received second firmware update data is written into the second firmware partition so as to load the second firmware update data in response to switching the running firmware to the second firmware. The present application provides a first firmware partition and a second firmware partition, wherein the first firmware stored by the first firmware partition only includes a minimum code set for implementing remote firmware update of the second firmware, and thus the size of the first firmware may be minimized, thereby reducing the demands for storage space of hardware of embedded devices and saving on the costs of hardware. In addition, more hardware resources may be reserved for the device to implement other functions, providing the possibility for integrating more device functions into embedded devices. At the same time, compared with the existing art, this solution may leave more space for the second firmware to implement richer functions by minimizing the size of the first firmware within limited hardware resources. In addition, the present application also provides an embedded device having the above technical advantages.

### BRIEF DESCRIPTION OF THE DRAWINGS

The present application will be further explained hereinafter based on embodiments with reference to the accompanying drawings.

FIG. 1 illustrates a schematic diagram of storage space partitioning for implementing “ping-pong” upgrade;

FIG. 2 schematically illustrates the setup of storage partitions of an embedded device in a firmware update method for an embedded device provided in the present application;

FIG. 3 schematically illustrates a flowchart of a specific implementation of the firmware update method for an embedded device provided in the present application;

FIG. 4 schematically illustrates a flow chart of another specific implementation of the firmware update method for an embedded device provided in the present application;

FIG. 5 schematically illustrates a flow chart of a further specific implementation of the firmware update method for an embedded device provided in the present application;

FIG. 6 schematically illustrates a flow chart of yet a specific implementation of the firmware update method for an embedded device provided in the present application;

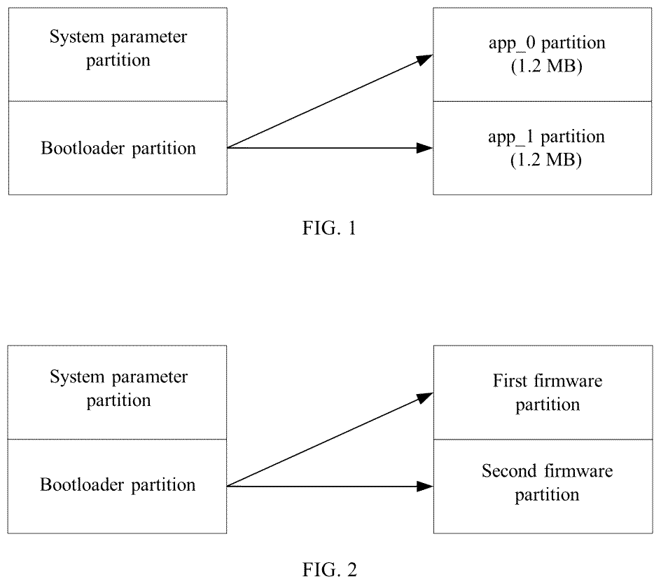

### DETAILED DESCRIPTION

The method and system of the present application will be described in detail below in combination with the accompanying drawings and specific implementations. It is to be appreciated that the embodiments shown in the accompanying drawings and described below are merely illustrative and not intended to limit the present application.

FIG. 2 illustrates the setup of storage partitions of an embedded device in a firmware update method for an embedded device provided in the present application. Referring to FIG. 2, a memory of the embedded device is provided with a first firmware partition, a second firmware partition, a bootloader partition, and a system parameter partition. The memory is a non-volatile memory, such as a Flash, a hard disk or other storage device.

The first firmware partition is configured to store a first firmware, and the first firmware includes a minimum code set for implementing remote firmware update of a second firmware. It is appreciated that the first firmware is only configured to implement the function of receiving the second firmware update data and writing the second firmware update data into the second firmware partition, and does not include other functions of the device.

Furthermore, in order to minimize the size of the first firmware, the received firmware may not be verified in the first firmware, and the signature information and the hash value of the firmware may be verified or decrypted by the bootloader. Other parameters of the system are not managed either, thereby ensuring that the size of the first firmware is small enough. Data such as system configuration, secure connection, network information may be shared with the second firmware.

The second firmware partition is configured to store at least one second firmware. The second firmware may include complete functions of the device, including but not limited to firmware remote update function, firmware switching function, system parameter management function, etc. During normal operation of the device, the second firmware is loaded into the internal storage and run to accomplish the necessary functions of the device, such as modifying device parameters, reporting collected data, and performing data processing. There may be a plurality of second firmware, each configured to implement a different device function, and all of the second firmwares may be remotely updated by the first firmware.

The bootloader partition is configured to store a bootloader program and load the first firmware and the second firmware. In addition, the bootloader program may perform the functions of detecting system parameters, verifying firmware, and determining which firmware to load and run.

The system parameter partition is configured to store system configuration, network connection information, system boot parameters and other information. It is appreciated that the system parameter partition may be divided into a plurality of partitions for management in an actual device, which is not defined here.

With the setup of the above partitions, the second firmware may be remotely updated by running the first firmware, and of course the first firmware may also be remotely updated by running the second firmware. The following embodiments describe the process of how to remotely update the second firmware by the first firmware.

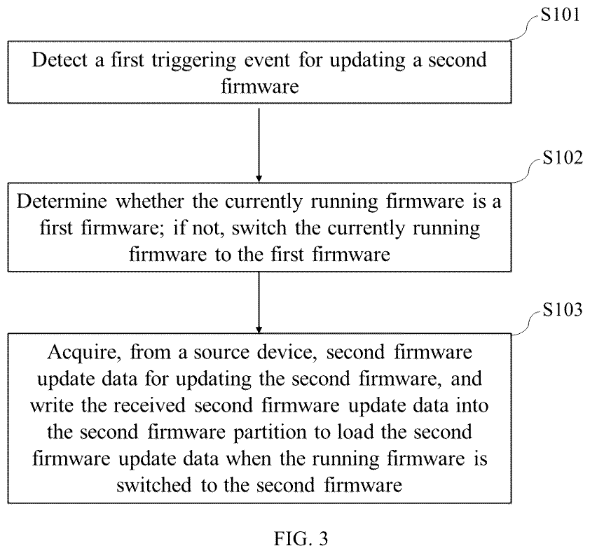

FIG. 3 illustrates a flowchart of a specific implementation of the firmware update method for an embedded device provided in the present application. Referring to FIG. 3, the method specifically includes:

Step S101: detect a first triggering event for updating a second firmware.

The first triggering event may be: receiving a push message sent by the source device indicating that there is an updated version of the second firmware. The push message may include the version number of the new firmware, the download link of the new firmware, verification data and other information. In addition, the first triggering event may also be: sending a query request to the source device as to whether there is an updated version of the second firmware, and receiving a reply message from the source device indicating that there is an updated version. The embedded device may actively send the above query request to the source device at regular intervals or at each power-up.

It should be appreciated that the “source device” herein refers to any computing device that provides firmware update data to an embedded device of which firmware is to be upgraded. For example, the source device may be a cloud server, a local server, a node of a mesh network, or a device of a Bluetooth Low Energy (BLE) network. It should be appreciated that the source device may be located in the cloud or locally. The source device and the embedded device may communicate with each other by means of Wi-Fi, Bluetooth, ZigBee, Ethernet, etc. The specific implementation is compatible with various communication methods and is not defined here.

Step S102: determine whether the currently running firmware is the first firmware; if not, switch the currently running firmware to the first firmware.

When it is detected that the second firmware needs to be updated, determine whether the currently running firmware is the first firmware. If the currently running firmware is the first firmware, the subsequent remote update operation for the second firmware may be directly performed. If the currently running firmware is the second firmware, it is necessary to switch the currently running firmware to the first firmware so as to update the second firmware in the second firmware partition by the first firmware.

Step S103: acquire, from a source device, second firmware update data for updating the second firmware, and write the received second firmware update data into the second firmware partition so as to load the second firmware update data when the running firmware is switched to the second firmware.

As a specific implementation, the process of writing the received second firmware update data into the second firmware partition may be done in either a full update manner or an incremental update manner. As a preferred implementation, the embodiments of the present application may remotely update the second firmware by adopting the full update manner.

The process of full update is specified as follows: the second firmware update data is the updated second firmware data, and the received second firmware data is directly replaced with the old second firmware data and written into the second firmware partition. The process of incremental update is specified as follows: the second firmware update data is the differential data between the old second firmware data and the updated second firmware data, and the received differential data is synthesized with the old second firmware data to generate the updated second firmware data, which is written into the second firmware partition.

The present application sets up a first firmware partition and a second firmware partition, wherein the first firmware partition stores the first firmware, which only includes a minimum code set for implementing remote firmware update of the second firmware, and thus the size of the first firmware may be minimized, thereby reducing the demands for storage space of hardware of embedded devices and saving on the costs of hardware. In addition, more hardware resources may be used for implementing other functions, providing the possibility for integrating more device functions into embedded devices.

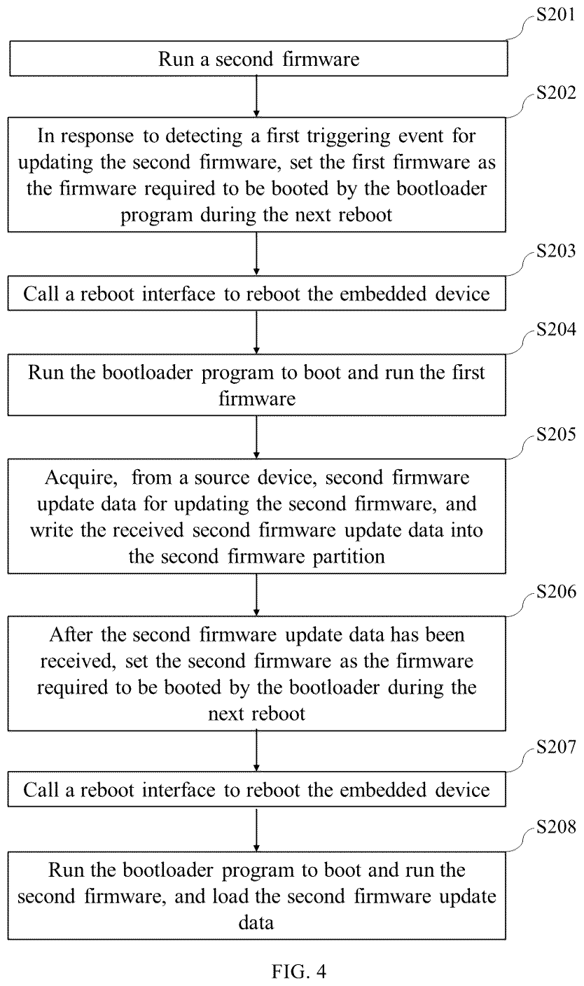

A flowchart of another specific implementation of the firmware update method for an embedded device provided in the present application is shown in FIG. 4, and the method specifically includes:

Step S201: run a second firmware.

After the embedded device system is powered on, the embedded device system enters the bootloader. Read the firmware boot identifier in the system parameter partition to determine whether to load the second firmware in the second firmware partition. If yes, run the second firmware.

Step S202: in response to detecting a first triggering event for updating the second firmware, set the first firmware as the firmware required to be booted by the bootloader program during the next reboot;

Specifically, the detection of the first triggering event may be triggered in the second firmware by means of buttons, touch screens or network communications. If the first triggering event is detected, the system parameters are rewritten to set the first firmware as the firmware required to be booted by the bootloader program during the next reboot;

Step S203: call a reboot interface to reboot the embedded device.

Step S204: run the bootloader program to boot and run the first firmware.

Step S205: acquire, from a source device, second firmware update data for updating the second firmware, and write the received second firmware update data into the second firmware partition.

In the first firmware, information about downloading the second firmware update data is obtained by querying the information of the system parameter partition or using buttons, touch screens, etc., a connection is established with the source device, the second firmware update data sent by the source device is received, and the received second firmware update data is written into the second firmware partition.

Step S206: after the second firmware update data has been received, set the second firmware as the firmware required to be booted by the bootloader during the next reboot;

Step S207: call a reboot interface to reboot the embedded device.

Step S208: run the bootloader program to boot and run the second firmware, and load the second firmware update data.

As a specific implementation, in the firmware update method for an embedded device provided by the present application, there may be a plurality of second firmware, each configured to implement a different function. Among them, at least one second firmware includes a code set for implementing firmware update for the first firmware.

Preferably, only one of the plurality of second firmware includes a code set for implementing firmware update for the first firmware, and only the corresponding second firmware has the function of updating the first firmware. For example, in an embodiment where the first firmware partition stores one first firmware and the second firmware partition stores three second firmwares, only one second firmware is configured to implement the update of the first firmware, that is, this second firmware may implement both the firmware functions and the update of the first firmware, and the remaining two second firmwares are only configured to implement the firmware functions. It is appreciated that the firmware functions here include, for example: Wi-Fi connection, recording video, initializing cameras, responding to camera-controlled signals, etc., but do not include the function of updating the first firmware. It is assumed that 50 KB is required to implement the FOTA function and 150 KB is required to implement the firmware function, if the prior art is used to perform the firmware update, the required storage space is 3*200 KB-600 KB, whereas by the method of the embodiments of the present application, the required storage space is 50 KB+200 KB (for the second firmware implementing the firmware function and updating the first firmware)+2*150 (for the remaining two second firmwares only implementing the firmware function)=550 KB. It can be seen that this embodiment is able to achieve the effect of saving the corresponding hardware space when there is a plurality of second firmwares.

As a specific implementation, before booting and running the second firmware, the method further includes: determining whether the second firmware is encrypted firmware, and if so, performing a decryption operation in the bootloader partition.

As a specific implementation, before booting and running the second firmware, the method further includes: performing signature information verification, and/or hash value verification, and/or file header information verification on the second firmware in the bootloader partition; if the verification passes, booting and running the second firmware.

When there is a plurality of second firmwares, after the performing signature information verification, and/or hash value verification, and/or file header information verification on the second firmware, the method further includes: if the second firmware to be booted fails the verification, traversing through other second firmwares in the embedded device to perform signature information verification, and/or hash value verification, and/or file header information verification; if the verification passes, booting and running the second firmware that has passed the verification. When the second firmware to be booted fails the verification, the bootloader program may traverse through all of the executable second firmwares, attempt to find firmware that may pass the verification, and load the firmware that has passed the verification.

Alternatively, when there is only one second firmware, after the performing signature information verification, and/or hash value verification, and/or file header information verification on the second firmware, the method further includes: if the second firmware to be booted fails the verification, returning to run the first firmware; if the verification passes, booting and running the second firmware.

This embodiment may ensure that the loaded firmware is normal and safe by performing a verification operation in the bootloader partition, thereby increasing the security of the system.

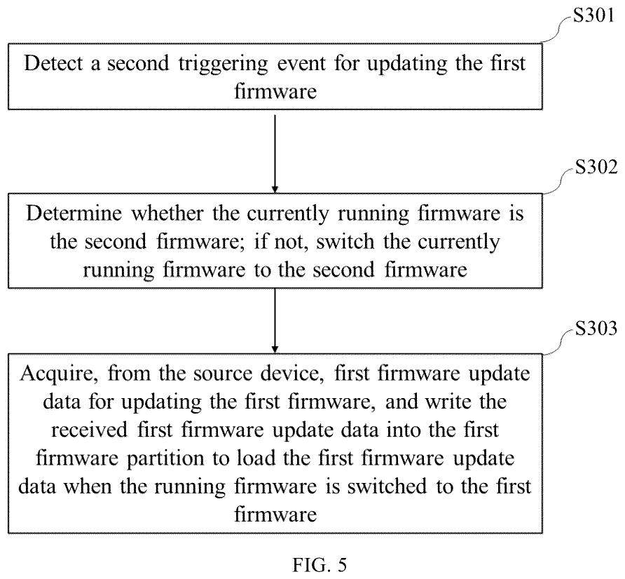

The following describes the process of remotely updating the first firmware by the second firmware in the firmware update method for an embedded device provided in the present application. FIG. 5 shows a flowchart of a further specific implementation of the firmware update method for an embedded device provided by the present application, the method specifically includes:

Step S301: detect a second triggering event for updating the first firmware.

Specifically, the detection of the second triggering event may be triggered in the second firmware by means of buttons, touch screens, or network communications. The second triggering event may be: receiving a push message sent by a source device indicating that there is an updated version of the first firmware. The push message may include the version number of the new firmware, the download link of the new firmware, verification data and other information. In addition, the second triggering event may also be: sending a query request to the source device as to whether there is an updated version of the first firmware, and receiving a reply message from the source device indicating that there is an updated version. The embedded device may actively send the above query request to the source device at regular intervals or at each power-up.

Step S302: determine whether the currently running firmware is the second firmware; if not, switch the currently running firmware to the second firmware.

When it is detected that the first firmware needs to be updated, determine whether the currently running firmware is the second firmware. If the currently running firmware is the second firmware, the subsequent remote update operation for the first firmware may be directly performed. If the currently running firmware is not the second firmware, it is necessary to switch the currently running firmware to the second firmware so as to update the first firmware in the first firmware partition by the second firmware.

Step S303: acquire, from the source device, first firmware update data for into the first firmware partition so as to load the first firmware update data when the running firmware is switched to the first firmware.

Writing the received first firmware update data into the first firmware partition may be done in either a full update manner or an incremental update manner. As a preferred implementation, the embodiments of the present application may remotely update the first firmware by adopting an incremental update.

The process of full update is specified as follows: the first firmware update data is the updated first firmware data, and the received first firmware data is directly replaced with the old first firmware data and written into the first firmware partition. The process of incremental update is specified as follows: the first firmware update data is the differential data between the old first firmware data and the updated first firmware data, and the received differential data is synthesized with the old first firmware data to generate the updated first firmware data, which is written into the first firmware partition.

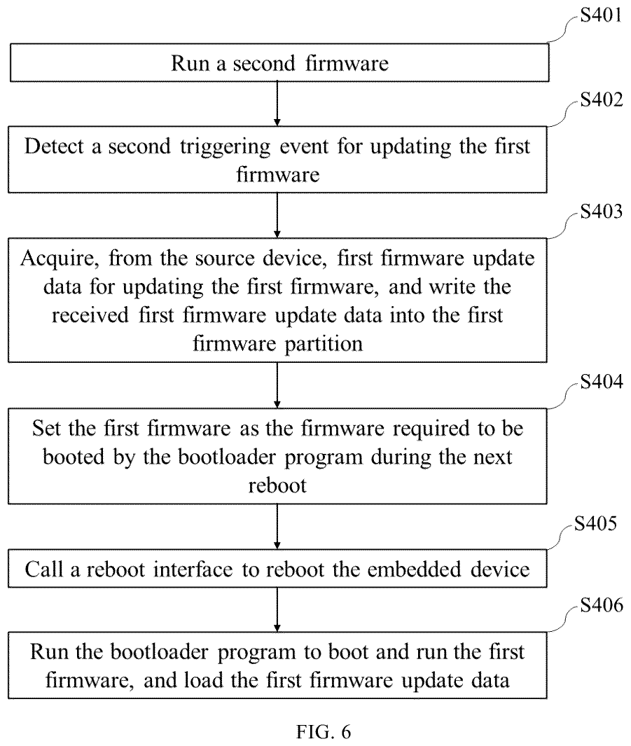

A flowchart of yet a specific implementation of the firmware update method for an embedded device provided in the present application is shown in FIG. 6, and the method specifically includes:

Step S401: run a second firmware.

After the embedded device system is powered on, the embedded device system runs the second firmware.

Step S402: detect a second triggering event for updating the first firmware.

Specifically, the detection of the second triggering event may be triggered in the second firmware by means of buttons, touch screens, or network communications.

Step S403: acquire, from the source device, first firmware update data for into the first firmware partition.

Read the connection information in the system parameter partition, establish a connection with the source device, receive the first firmware update data sent by the source device, and write the first firmware update data into the first firmware partition.

Step S404: set the first firmware as the firmware required to be booted by the bootloader program during the next reboot.

Step S405: call a reboot interface to reboot the embedded device.

Step S406: run the bootloader program to boot and run the first firmware, and load the first firmware update data.

Before booting and running the first firmware, the method further includes: performing signature information verification, and/or hash value verification, and/or file header information verification on the first firmware in the bootloader partition; if the verification passes, booting and running the first firmware. Performing verification before booting the firmware may improve the security of the system.

In addition, after writing the received first firmware update data into the first firmware partition at S403, it is not necessary to immediately switch to the first firmware for remote update. The embodiments of the present application may switch the currently running firmware to the first firmware and load the first firmware update data next time the second firmware needs to be updated, that is, when the first triggering event for updating the second firmware is detected.

It can be seen that the present application provides a first firmware partition and a second firmware partition, wherein the first firmware stored by the first firmware partition only includes a minimum code set for implementing remote firmware update of the second firmware, and thus the size of the first firmware may be minimized, thereby reducing the demands for storage space of hardware of embedded devices and saving on the costs of hardware. In addition, more hardware resources may be used for implementing other functions, providing the possibility for integrating more device functions into embedded devices. The present application is particularly suitable for embedded devices of which main program functions are complex but remote update functions are relatively simple to implement.

In the method provided in the present application, two firmwares may each accomplish a remote update to the other firmware, thereby ensuring that both running firmware may be upgraded to fix security vulnerabilities. Furthermore, if the firmware after a certain remote update cannot be loaded and run normally, another firmware including the remote update function can be used to remotely update the damaged firmware again. Two executable firmwares can enhance the reliability of the system and provide better fault tolerance.

In addition, with the method provided in the present application, developers only need to design the functions of two firmwares and deploy them on their own devices for use, which is simple to implement. The two firmwares employed use a unified firmware format, which is convenient for management or the use of a unified signature format, encryption, and adding verification data to develop more advanced functions. Embedded devices from different manufacturers may all use the method provided in the present application to implement firmware updates, which may be used across platforms and has a wider scope of application. Moreover, devices that use compressed updates and incremental updates require more internal storage to perform decompression and inverse differential processes in addition to the functions of downloading and saving the downloaded data to a designated storage area, whereas the method in the present application consumes less internal storage and helps to improve the market competitiveness of embedded devices.

In addition, the present application also provides an embedded device, referring to FIG. 2, wherein a first firmware partition, a second firmware partition and a bootloader partition are provided in a memory of the embedded device, wherein the first firmware partition is configured to store a first firmware, and the second firmware partition is configured to store at least one second firmware, the first firmware includes a minimum code set for implementing remote firmware update of the second firmware, the bootloader partition is configured to load the first firmware and the second firmware, and the firmware stored in the memory is loaded into the internal storage of the embedded device to implement any of the firmware update method for an embedded device as described above.

The memory is a non-volatile memory.

Taking a Wi-Fi webcam based on the ESP32 microcontroller unit provided by Espressif Systems as an example, the main function of this device is to record video, control the camera's shooting angle via Wi-Fi, and view the captured content in real time. As shown in Table 1, bootloader represents a bootloader program, ota_app represents a first firmware containing only a remote firmware update function, and main_app represents a second firmware implementing the main function of the device. In the solution provided in the embodiments of the present application, the size of the second firmware main_app is 1411 KB, the size of the bootloader is 62 KB, the size of the first firmware ota_app is 457 KB, and a new firmware is downloaded in ota_app via a Wi-Fi network connection and https communication protocols and written into the first firmware partition. The size of the compressed main_app firmware obtained by using the xz compression algorithm with excellent compression performance integrated under Linux is 721 KB.

Obviously, with the solution proposed in the present application, a firmware storage device of 2M size may be selected. A firmware storage device of at least 3M is required if the full update is used; and a firmware storage device of at least 2.3M is required if the compressed update based on the xz compression algorithm is used. It can be seen that the method provided in the present application saves hardware resources of embedded devices.

TABLE 1

| Name | Main Functions | Size | |
|---|---|---|---|
| bootloader | Initializing the system, detecting system | 62 | KB |
| | parameters, and verifying the specified | | |
| | firmware program to be booted | | |
| main_app | Wi-Fi connection, recording video, initializing | 1411 | KB |
| | cameras, responding to camera-controlled signals | | |
| | and FOTA functions, etc. | | |
| ota_app | Wi-Fi connection, updating firmware of the | 457 | KB |
| | main_app partition | | |

While various embodiments of various aspects of the disclosure have been described for the purpose of this disclosure, it shall not be appreciated that the teaching of this disclosure is limited to these embodiments. The features disclosed in a specific embodiment are therefore not limited to that embodiment, but may be combined with the features disclosed in different embodiments. For example, one or more features and/or operations of the method according to the present application described in one embodiment may also be applied alone, in combination or as a whole in another embodiment. Those skilled in the art will understand that there are more possible optional implementations and variants, and various changes and modifications may be made to the above systems without departing from the scope defined by the claims of the present application.

1. A firmware update method for an embedded device, wherein a first firmware partition, a second firmware partition and a bootloader partition are provided in a memory of the embedded device, wherein the first firmware partition is configured to store a first firmware, the second firmware partition is configured to store at least one second firmware, the first firmware comprises a minimum code set for implementing remote firmware update of the second firmware, the bootloader partition is configured to load the first firmware and the second firmware, and the method comprises:
detecting a first triggering event for updating the second firmware;
determining whether a currently running firmware is the first firmware, and if not, switching the currently running firmware to the first firmware; and
acquiring, from a source device, second firmware update data for updating the second firmware, and writing received second firmware update data into the second firmware partition to load the second firmware update data in response to switching a running firmware to the second firmware.

2. The firmware update method for an embedded device according to claim 1, wherein the first triggering event comprises any one of the following:
receiving a push message sent by the source device indicating that there is an updated version of the second firmware; and
sending a query request to the source device as to whether there is an updated version of the second firmware, and receiving a reply message from the source device indicating that there is an updated version.

3. The firmware update method for an embedded device according to claim 1, wherein the writing received second firmware update data into the second firmware partition comprises one of:
the second firmware update data is updated second firmware data, replacing the received second firmware data directly with the old second firmware data and writing the received second firmware data into the second firmware partition; and
the second firmware update data is differential data between the old second firmware data and the updated second firmware data, synthesizing the received differential data with the old second firmware data to generate updated second firmware data and writing the updated second firmware data into the second firmware partition.

4. The firmware update method for an embedded device according to claim 1, wherein the switching currently running firmware to the first firmware comprises:
setting the first firmware as the firmware required to be booted by the bootloader program on the next reboot;
calling a reboot interface to reboot the embedded device; and
running the bootloader program to boot and run the first firmware.

5. The firmware update method for an embedded device according to claim 1, wherein the loading the second firmware update data in response to switching the running firmware to the second firmware comprises:
setting the second firmware as the firmware required to be booted by the bootloader program on the next reboot;
calling a reboot interface to reboot the embedded device; and
running the bootloader program to boot and run the second firmware, and loading the second firmware update data.

6. The firmware update method for an embedded device according to claim 5, wherein before the booting and running the second firmware, the method further comprises:
determine whether the second firmware is encrypted firmware, and if yes, performing a decryption operation in the bootloader partition.

7. The firmware update method for an embedded device according to claim 5, wherein before the booting and running the second firmware, the method further comprises:
performing at least one of signature information verification, and hash value verification, and/or file header information verification on the second firmware in the bootloader partition; and
in response to that the verification passes, booting and running the second firmware.

8. The firmware update method for an embedded device according to claim 7, wherein when there is a plurality of second firmwares, after performing at least one of signature information verification, hash value verification, and file header information verification on the second firmware, the method further comprises:
in response to that the second firmware to be booted fails the verification, traversing through other second firmwares in the embedded device to perform at least one of signature information verification, and hash value verification, and file header information verification;
in response to that the verification passes, booting and running the second firmware that has passed the verification.

9. The firmware update method for an embedded device according to claim 1, further comprising:
detecting a second triggering event for updating the first firmware;
determine whether the currently running firmware is the second firmware, and if not, switching the currently running firmware to the second firmware;
acquiring, from the source device, first firmware update data for updating the first firmware, and writing received first firmware update data into the first firmware partition to load the first firmware update data in response to switching the running firmware to the first firmware.

10. The firmware update method for an embedded device according to claim 9, wherein the writing received first firmware update data into the first firmware partition comprises one of:
the first firmware update data is updated first firmware data, replacing the received first firmware data directly with the old first firmware data and writing the received first firmware data into the first firmware partition; and
the first firmware update data is differential data between the old first firmware data and the updated first firmware data, synthesizing the received differential data with the old first firmware data to generate updated first firmware data and writing the updated first firmware data into the first firmware partition.

11. The firmware update method for an embedded device according to claim 9, wherein the loading the first firmware update data in response to switching the running firmware to the first firmware comprises:
setting the first firmware as the firmware required to be booted by the bootloader program on the next reboot;
calling a reboot interface to reboot the embedded device;
running the bootloader program to boot and run the first firmware, and loading the first firmware update data.

12. The firmware update method for an embedded device according to claim 11, wherein before the booting and running the first firmware, the method further comprises:
performing at least one of signature information verification, and hash value verification, and file header information verification on the first firmware in the bootloader partition;
in response to that the verification passes, booting and running the first firmware.

13. The firmware update method for an embedded device according to claim 1, wherein the source device is one of a cloud server, a local server, a node of a mesh network, and a low-power Bluetooth network device.

14. The firmware update method for an embedded device according to claim 1, wherein when there is a plurality of second firmwares, only one of the second firmwares comprises a code set for implementing firmware update of the first firmware.

15. An embedded device, wherein a first firmware partition, a second firmware partition and a bootloader partition are provided in a memory of the embedded device, wherein the first firmware partition is configured to store a first firmware, the second firmware partition is configured to store at least one second firmware, the first firmware comprises a minimum code set for implementing remote firmware update of the second firmware, the bootloader partition is configured to load the first firmware and the second firmware, and the firmware stored in the memory is loaded into internal storage of the embedded device to implement the firmware update method for an embedded device according to claim 1.

16. The embedded device according to claim 15, wherein the memory is a non-volatile memory.

17. The firmware update method for an embedded device according to claim 7, when there is one second firmware, after the performing at least one of signature information verification, and hash value verification, and file header information verification on the second firmware, the method further comprises:
in response to that the second firmware to be booted fails the verification, returning to run the first firmware;
in response to that the verification passes, booting and running the second firmware.
